(19) United States
(12) Patent Application Publication
(10) Pub. No.: US 2015/0293612 A1
(43) Pub. Date: Oct. 15, 2015

(54) PEN-TYPE OPTICAL INDEXING APPARATUS AND METHOD FOR CONTROLLING THE SAME

(71) Applicants: Yun-Shan Chang, San Jose, CA (US); Da-Wei Lin, (US)

(72) Inventor: YUN-SHAN CHANG, SAN JOSE, CA (US)

(73) Assignees: YUN-SHAN CHANG, SAN JOSE, CA (US); DA-WEI LIN, NEW TAIPEI CITY (TW)

(21) Appl. No.: 14/248,433

(22) Filed: Apr. 9, 2014

(51) Int. Cl. G06F 3/0354; G06F 1/26; G06F 3/038

(52) U.S. Cl. CPC G06F 3/03545; G06F 3/0386; G06F 1/26

(57) ABSTRACT

Provided is to a pen-type optical indexing apparatus and a method for controlling the same. The apparatus is a handheld device conveniently provided for a user to manipulate. Housing of the apparatus has an opening in the end, and the opening is a passage allowing emitting and receiving lights. The apparatus essentially includes a control unit for integrating the internal signals, a control interface unit provided for manipulating the apparatus to generate control signals, and an integrated circuit which packages a light-source module and a sensing module of the apparatus. The sensing module includes a sensor array composed of multiple sensing cells arranged in an array, and is used to sense the incident lights reflected by an external object. The apparatus includes a communication unit and a power management unit. One of operational modes including cursor-indicating mode, handwriting mode and touching mode can be activated while initiating the apparatus.

### BACKGROUND

1. Technical Field

The present invention generally relates to a pen-type optical indexing apparatus and a control method, in particular, to a pen-type optical indexing apparatus disposed with a laser module and arrayed sensor components.

2. Description of Related Art

The conventional pen-shaped indicator is designed for the users conveniently controlling computer cursor just like using the general computer mouse. The indicator is also an auxiliary handheld tool for computer graphics.

The general passive pen-shaped indicator requires an extra mutual inductance device for the plotting board or handwriting plate. Therefore, when the pen-shaped indicator touches the plotting board paved with circuits for generating electric field, a mutual inductance effect is induced to generate signals for cursor indication or plotting.

However, the conventional indicator such as the mechanical, optical computer mouse, mouse wheel, or the touch stylus is provided, it cannot provide qualified resolution or accuracy to trace two-dimensional movement.

The conventional optical sensor utilized in the optical indicator is the sensing component such as Complementary metal-oxide-semiconductor (CMOS), or Charge-coupled Device (CCD) that converts the received light signals into electric signals. A certain optical intensity (energy) may be captured by these sensors in general. By this scheme, in addition to capturing images, a distance sensor may be implemented for the sensor is able to determine the distance from a light source. The sensor is also used to calculate the energy change with time.

An optical indexer is such as a computer mouse that is used to determine a moving track by the inside optical sensor. While a light emitted to an operative surface, a moving vector may be determined by the sensor to collect the energy change within a time interval and to perform image processing.

The light source continuously emits lights to the surface with a specific angle while the optical mouse operates. A sensor receives reflected light from the surface. The sensor may obtain a distribution diagram made by the reflected light. The controller then obtains a moving direction of the optical mouse by analyzing the energy distribution.

In the conventional technology that determines the moving track of the optical mouse, the contact surface may dominate the performance of tracking the optical mouse since the signals of reflected light made by the surface is the essential information.

Furthermore, a capacitance-type stylus is existed. While the capacitance value induced between the stylus and a touch display is changed, the change is a reference to determine the movement. Therefore, the determination of movement may be used to control cursor and perform plotting. The low resolution may require assistance of software to improve performance.

For the purpose of light tracing, the conventional technology may not function well when the optical indexer moves over a transparent surface or the surface that not easily reflects the light. These types of surfaces may cause the failure to determine the movement.

In the conventional technologies, some of them use additional positioning measures to acquire the moving tracks, or some use additional complicated algorithm to maintain a certain ability of tracing the movement. However, theses positioning measures or algorithm may be limited to some types of surfaces because of the limitations of sensitivity, high energy consumption, and complexity. However, these technologies are not applicable to or achieve light tracing over every surface with too high or too low reflectivity.

### SUMMARY

The present invention is related to a pen-type optical indexing apparatus and a control method thereof. The pen-type optical indexing apparatus is an apparatus for the user to hold conveniently. According to one of the embodiments, a light passage is formed on the housing of the optical indexing apparatus. A circuit module used to process the signals made by computing the sensed lights is disposed inside the housing. The circuit module includes a control unit which is used to integrate the internal signals within the pen-type optical indexing apparatus, and to generate the movement signals. The circuit module includes a control interface unit which is provided for the user to manipulate the apparatus so as to generate control signals. The control interface unit may be a wheel or buttons disposed on the housing. A light-source module is also included and utilized to emit lights from the optical indexing apparatus. The lights are emitted out of the apparatus through a light passage of the housing. The light source is preferably a laser with great spatial coherence. The sensing module includes a sensor array having multiple sensing cells arranged in an array. The sensor array is used to receive the lights entering the optical indexing apparatus. The circuit has a communication unit provided to communicate with a computer host. A power management unit is also included in the circuit module. The power management unit is electrically connected with a charging module, for example a solar energy charging module.

While computing the energy received by the every sensing cell of the sensing module before and after a sampling time, an energy difference of spatial interference around the sampling time can be obtained. The energy difference is used to determine a moving direction of the optical indexing apparatus. A movement signal is therefore generated.

According to one further embodiment, the control unit, the light-source module, and the sensing module are integrated into one integrated circuit.

In one embodiment of the control method, one of operational modes may be initiated as activating the pen-type optical indexing apparatus. A tangible switch is provided for the user to select one of the operational modes, preferably including a cursor-indicating mode, a handwriting mode, and the touching mode.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 shows a schematic diagram illustrating a light path of the incident light irradiating a surface and the reflective light;

FIG. 2 shows a schematic diagram depicting a sensor array integrated into one integrated circuit in accordance with one embodiment of the present invention;

FIG. 3 shows a circuit block describing the circuits of the pen-type optical indexing apparatus in one embodiment of the present invention;

FIG. 4 shows a schematic diagram illustrating circuits made to the pen-type optical indexing apparatus in one embodiment of the present invention;

FIG. 5 schematically shows the pen-type optical indexing apparatus according to first embodiment of the present invention;

FIG. 6 schematically shows the optical indexing apparatus according to second embodiment of the present invention;

FIG. 7 schematically shows the optical indexing apparatus according to third embodiment of the present invention;

FIG. 8 schematically shows the optical indexing apparatus according to fourth embodiment of the present invention;

FIG. 9 shows a flowchart describing the steps for controlling the pen-type optical indexing apparatus according to one embodiment of the present invention;

FIG. 10 shows a schematic diagram of the sensor array adopted by the apparatus in one embodiment of the present invention;

FIG. 11 schematically shows a layout of the sensing cells arranged in an cursor control apparatus of the present invention;

FIG. 12 shows an exemplary diagram describing the method of light tracing in the sensing cells in one embodiment of the present invention;

FIG. 13 shows another exemplary diagram describing the method of light tracing in the sensing cells in another embodiment of the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

For the purpose of providing a handheld indexing apparatus operated over a variety of types of surfaces, disclosure herein is related to a pen-type optical indexing apparatus and a control method. The pen-type optical indexing apparatus may be optionally operated under a cursor-indicating mode. Therefore the apparatus generates signals to control the computer cursor while the pen-type optical indexing apparatus operates over a surface. The apparatus may also be operated under a handwriting mode. The apparatus therefore generates signals to draw a continuous track while the pen-type optical indexing apparatus operates over another surface. While the apparatus operates under a touching mode, the pen-type optical indexing apparatus is allowed to operate on a touch display. The apparatus generates indication signals on the touch display. It is noted that, under the touching mode, the touch display may deactivate its touching function for the reason of preventing interference made to the indication signals for the touch display under the touching mode.

The pen-type optical indexing apparatus is particularly disposed with an optical indexing module inside its hollow tube. The invention disclosed in the disclosure renders the effect of indication with high resolution and high accuracy. The technology related to the optical indexing module introduces a sensor array essentially composed of a plurality of sensing cells arranged in an array. In one embodiment in the disclosure, the sensor array forms an optical sensing unit which is used to receive reflected lights from a surface and converts the light signals into the energy signals for used to determining movement. While the plurality of sensing cells receive the lights, it may acquire constructive or destructive interference patterns from the energies of the reflected lights. The energy changes within a period of time may be calculated to determine a moving vector of the apparatus. The movement relative to the surface may be determined, especially to an optical indexer.

In particular, a coherent light or said the light with great spatial coherence is preferably applied as the light source. The coherent light allows the determination of the moving tracks to be more efficient. The determination may be cooperated with a scheme of sensitivity compensation that employs a movement recognition algorithm for light tracing. By which, the light tracing method can be applied to the various type of surfaces.

In one embodiment, a scheme of coherent light source package integration is introduced to the pen-type optical indexing apparatus according to one embodiment of the disclosed invention. The optical indexing module in the apparatus needs not to mount any additional optical lens or specific image sensor, for example the CMOS image sensor (CIS). The optical indexer in accordance with the present invention needs no any disposal of optical components such as lens and reflectors along the light path. The reflected lights may be directly received by the optical sensing cells. The energy difference within a time interval is used to detect the movement of the pen-type optical indexing apparatus held by the user.

The optical indexing module of the pen-type optical indexing apparatus according to the disclosure preferably incorporates the light source with good spatial coherence, e.g. Laser. The indexer having the array-formed sensor chip is operated with a light tracing algorithm.

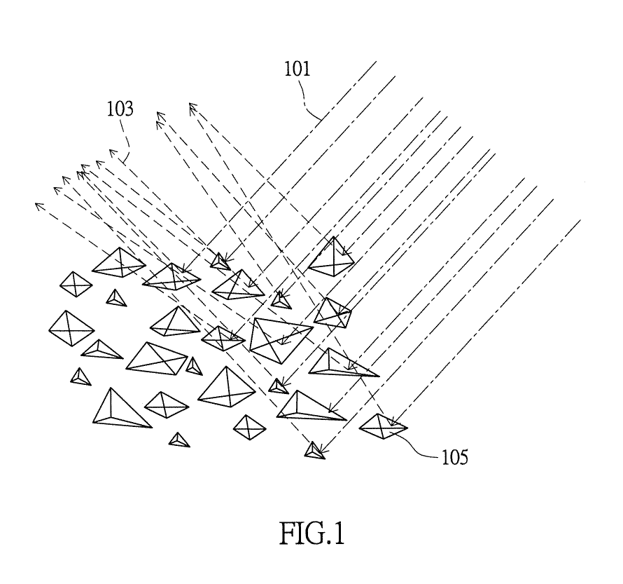

Reference is made to FIG. 1 depicting an incident light (11) made by a specific light source (not shown) emitted to a surface and then reflected (13). Therefore multiple reflected light paths expressed by the multiple lines are generated. The light source may utilize Laser, the coherent light. It is noted that the described coherent light may also be the light with great spatial coherence.

The shown multiple light paths involving the paths indicative of incident lights 11 emitted to a surface with surface structure 15, and the paths for reflected lights 13. Within a microscopic view of field, the surface structure 15 has irregular structure that causes the multi-directional reflected lights 13 as shown in the diagram.

The light source may continuously generate the incident lights 11 to the surface, and form the reflected lights 13. The reflected lights 13 are received by the sensor (not shown), in which the lights form the optical constructive and destructive interference patterns. It is particular that the light source is a coherent light source that generates the coherent incident light allowing enhancing the interference effect.

When the apparatus installed with the circuits embodying the mentioned light tracing method moves over an X-Y plane, the photo sensor receives the reflected lights 13. The apparatus samples the signals within a period of sampling time, and calculates average energy of the reflected lights. After that, an energy difference in different times or at different positions may be obtained. The optical indexer according to the disclosure may preferably incorporate a sensor array that is used to obtain the energies at the different positions, and difference between the average energies. The moving track may therefore be determined. The calculation of the statistic average may include acquiring a statistic average from the energies received by all the sensing cells; or the average is made by part of the sensing cells. For example, the average is referred to the sensing cells over a row such as the X direction shown in FIG. 10; or over a column such as the Y direction. The energy average may also be calculated from the energies received by the surrounding sensing cells or centered pixels within a specific area.

In one of the embodiments incorporating the sensor array, the interference effect may be enhanced while the light source generates coherent light. It is noted that the coherent light introduces a very small phase delay within a wave envelope. The Laser is one type of the coherent lights rather than the non-coherent light such as sunlight or LED light.

To improve sensitivity of the optical sensor under the interface made by the reflected light, the coherent light is preferably introduced to the optical indexing module in the apparatus of the present invention. The coherent light may cause much small phase delay since it is featured to have less phase difference. To the spatial interference made by the non-coherent reflected light, the coherent light may cause comparative small phase delay. The coherent light may therefore advantage the spatial interference effect of the reflected light. The above-mentioned sensor array may calculate the difference of the spatial interface by the lights reflected from a surface.

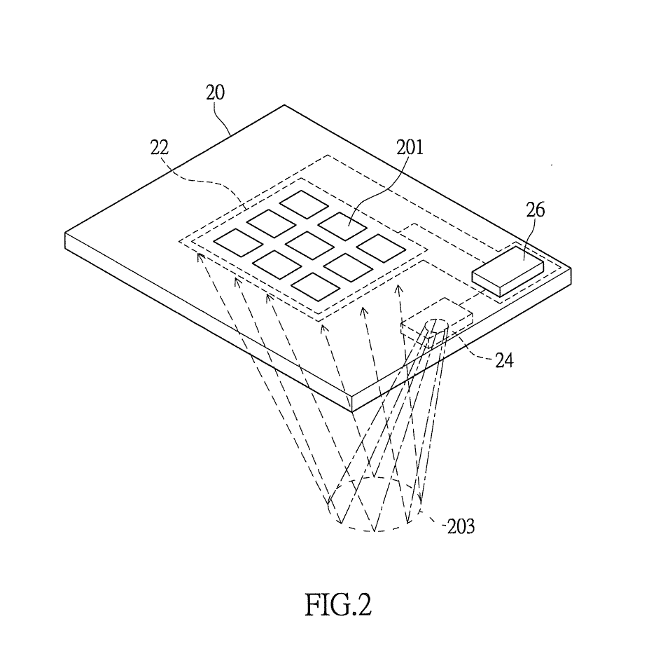

The sensor array such as the sensors shown in FIG. 2 disposed in the pen-type optical indexing apparatus is packaged into one IC. According to one of the embodiments, the sensor array and the related controlling circuits are integrated into one semiconductor circuit. The mentioned light source, sensor array, and the controller may be packaged onto a circuit board within the apparatus where the optical indexing module is embedded. Therefore, there is no need to install any optical sampling element such as lens or specific semiconductor process such as CIS so as to advance photosensitive sensitivity.

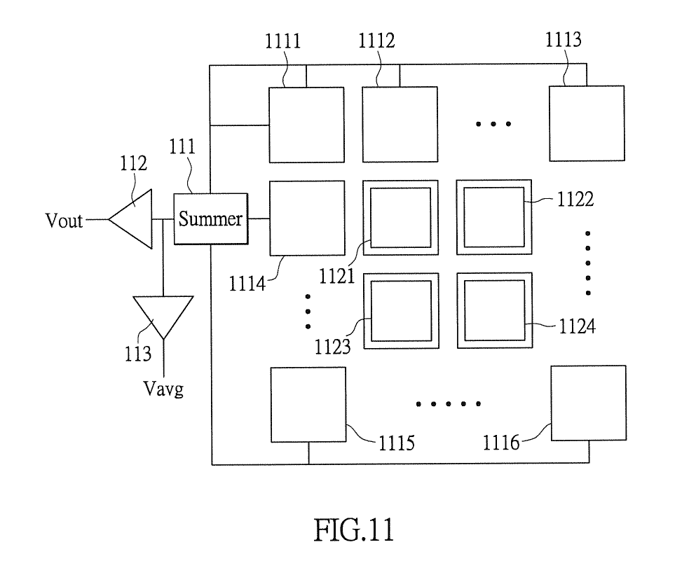

A circuit board 20 shown in the figure is installed in the pen-type optical indexing apparatus having the optical indexing module. A sensor array 22 is mounted onto the circuit board 20 of the apparatus. The sensor array 22 includes a plurality of sensing cells 201 arranged in an array. The sensing cells 201 are integrated into an IC. In particular, the sensor array 22 and the control circuit 26 are integrated. In particular, the sensing cells 201, especially the dummy sensing cells shown in FIG. 11, of the sensor array 22 may be configured to have a fixed distance and an even relative position existed between two adjacent sensing cells. The configuration allows the sensor array to receive the reflected lights evenly. The sensing cells 201 of the sensor array 22 may evenly receive the reflected lights from their fixed positions. A light-source device 24 schematically emits lights onto a surface and forms the shown illuminated area 203. The lights reflected from the surface may then emit the sensor array 22. The every sensing cell 201 receives the reflected light from different directions. A suitable photoelectric signal conversion may be applied to the signals received by the sensing cells 201. The control circuit 26 and related circuit are used to measure the statistic average of the energy by firstly summing up the energies received by the sensing cells 201. Next, the difference of the statistic average and the energy received by the every sensing cell 201 can be obtained. The spatial interference difference made by the lights reflected from the surface can be obtained. The control circuit 26 may therefore determine the moving direction by accumulating multiple energy differences within a period of a sampling time. It is noted that the preferred embodiment shows the light-source device 24 and integrated circuit having the sensor array 22 and control circuit 26 may be packaged into one single module.

About the spatial interference in the mentioned pen-type optical indexing apparatus, especially, but not limited to, the coherent light source emits lights to the irregular surface structure of the surface and then generates the reflected lights with different directions. The optical interference is therefore produced. Interaction made between the incident lights and the reflected lights produces constructive or destructive interference patterns. The sensor array may acquire the spatial information from the interference patterns since the apparatus moves relative to the surface. The information associated to the movement over X-Y plane is therefore established.

In one embodiment, a Laser device may be introduced to be the light source of the optical indexing module adopted in apparatus. In a circuit board (20), the essential elements of the apparatus include a light-source device (24) that is used to generate an incident light emitted to a surface; a sensor array (22) including multiple sensing cells (201) arranged in an array; a control circuit (26) coupled to the light-source device (24) and the sensor array (22), used to receive the light signals received by the sensing cells (201). The energy state of every sensing cell and the difference of the energy states within the period of sampling time can be acquired.

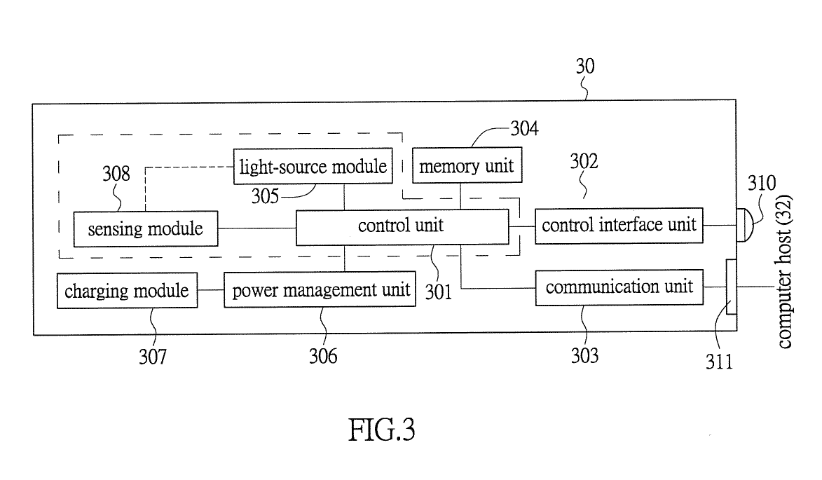

Reference is made to FIG. 3 showing a circuit block which describes the pen-type optical indexing apparatus according to one of the embodiments of the present invention.

The shown optical indexing apparatus 30 has a hollow pen tube according to one embodiment. A light passage is disposed on the housing the apparatus 30. The light passage is such as an opening thereon. Inside the pen tube, several circuits used to operate to generate the movement signals are included. The major circuit is such as a control unit 301 used to integrate the internal signals made in the optical indexing apparatus 30. The other circuits electrically connected to the control unit 301 are described as follows.

A control interface unit 302 is as a management circuit for the control interface 310. The control interface unit 302 includes the control interface 310 which is such as a wheel or button(s) disposed on the housing surface. The user manipulates the control interface 310 of the apparatus 30 to generate control signals. The control interface 310 may utilize a touch sensing component inside the hollow pen tube for sensing the finger gesture over the housing of the optical indexing apparatus 30. For example, the control interface 310 coupled to the control interface unit 302 is such as a tangible switch disposed on the housing. The switch is implemented by a wheel, buttons or a touch-sensitive interface. The control signals generated by the control interface unit 302 are transferred to the control unit 301, and converted into instructions. The instructions may be the instruction for simulating the commands made by the conventional computer mouse's wheel or buttons. The instructions also includes instruction for switching the operational mode of the pen-type optical indexing apparatus 30.

A light-source module 305 provides a light source, which is preferred to be a laser with great spatial coherence. The light source irradiates lights out of the optical indexing apparatus 30 through the light passage of the housing.

A sensing module 308 is included within the hollow pen tube of the apparatus 30, and used to receive lights reflected from an external object and entered into the apparatus 30. The sensing module 308 is preferred to be a sensor array composed of a plurality of sensing cells arranged in an array. The sensor array is used to receive the lights entering the apparatus 30 through the light passage of housing. While the lights reach the sensing module 308, the lights are averagely received by the sensing cells of the sensor array. The energy received by the every sensing cell of the sensing module 308 within a sampling time can be calculated. Then an energy difference of spatial interference around the sampling time can be obtained. The energy difference is a reference to determine a moving direction made by the pen-type optical indexing apparatus 30 relative to a surface. A movement signal is therefore generated.

The sensing module 308 may include a control circuit which is used to process the optical signals made by every sensing cell. The variation of energies may be calculated. The related description is referred to FIG. 10 and FIG. 11.

A communication unit 303 used to conduct wired or wireless communication for the apparatus 30 is included. The optical indexing apparatus 30 is communicated with a computer host 32 by the communication unit 303. The movement signal is transferred to the computer host 32 so as to form the instructions for controlling the cursor. The movement signals may also be converted to the instruction for drawing track under the handwriting mode. The movement signal may be converted into the touch instruction. The mentioned communication made between the apparatus 30 and the computer host 32 utilizes the protocol such as Bluetooth™, WiFi™, Near-Field Communication (NFC), or the like.

In an exemplary example using wired communication protocol, the pen-type optical indexing apparatus 30 is disposed with a connection interface 311, e.g. universal serial bus (USB). Via this connection interface 311, the apparatus 30 is communicated with the computer host 32. Furthermore, via this connection interface 311, the apparatus 30 may take electricity power from the connected computer host 32 or other kind of power source.

A power management unit 306 is included. The power management unit 306 is a circuit used to manage the power source charging the pen-type optical indexing apparatus 30, and the power for the apparatus 30. The power for the optical indexing apparatus 30 may be made by a charging module inside the apparatus 30. The charging module exemplarily includes a chargeable battery set. The charging module may also take power from the computer host 32 via USB, and to charge the chargeable battery set. The apparatus 30 is not excluding the other ways to charge the battery set. For example, the charging module may be a solar energy charging module, a wireless charging coil, or the module to charge the battery set over the cable connecting the computer host 32.

The optical indexing apparatus 30 further includes a memory unit 304 which is used to store data. The memory unit 304 may also to be a buffer memory for the exchanging data.

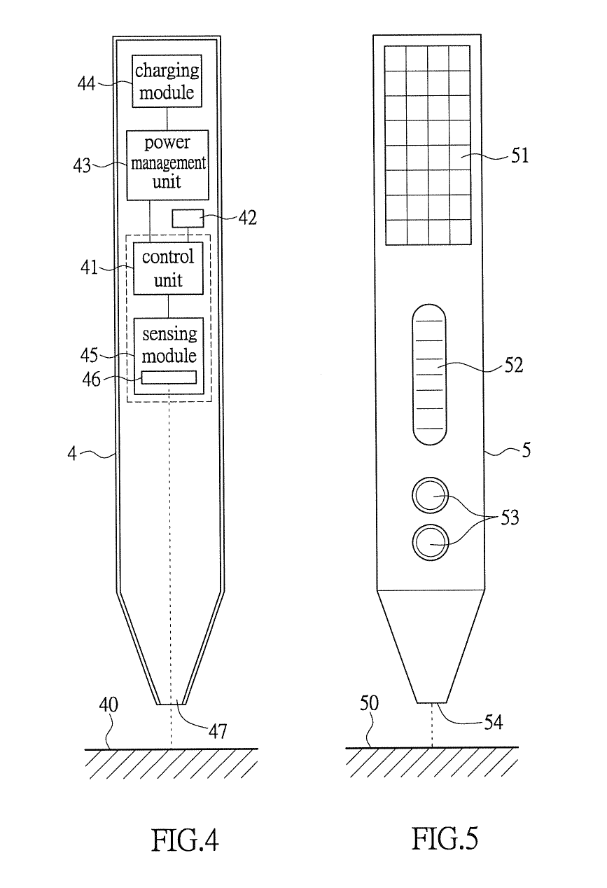

FIG. 4 shows a schematic circuit diagram describing the circuits inside the pen-type optical indexing apparatus according to one embodiment of the present invention.

In the exemplary example, a pen-type optical indexing apparatus 4 is shown. The apparatus 4 has a hollow pen tube where a control unit 41, a communication unit 42, a power management unit 43, a charging module 44, a sensing module 45, a light-source module 46, and a light passage 47 formed at the portion of pen tip are included. Outgoing lights are emitted by the light-source module 46 to a surface through the light passage 47. The lights reflected by the surface 40 re-enter the apparatus 4 through the light passage 47. The sensing cells arranged in an array in the sensing module 45 receive the reflected lights.

Outward appearance of the pen-type optical indexing apparatus 4 shows a pen-shaped indexing apparatus that is provided for users to easily handhold. The light passage 47 formed at the pen tip is as a light entrance of the pen-type optical indexing apparatus 4. Other than the portion of the pen tip is required to form a nearly vertical angle to the surface 40, the other portions of the apparatus 4 are not limited to any structure. The design of the optical indexing apparatus 4 may be varied as demands. It is noted that the angle of the portion of the pen tip nearly perpendicular to the surface 40 allows the outgoing lights of the pen-type optical indexing apparatus 4 to be reflected by the surface 40 through the light passage 47. The lights directed to the surface 40 are reflected back to the indexing apparatus 4 and received by the sensing module 45.

In one embodiment, one of the major circuits is such as the light-source module 46, preferably a control circuit for the light source, e.g. Laser module. The control circuit together with the sensing module 45 may be packaged in one circuit module. Further, light-source module 46, the sensing module 45, and the control unit 41 may also be integrated into one single integrated circuit (IC) using System on Chip (SOC) technology. The control unit 41 is used to connect to a computer host for signaling or delivering instructions. The communication unit 42 renders wired or wireless communication protocol with an external device. Via this communication unit 42, the control unit 41 is able to transmit signals to the computer host.

Further, the power management unit 43 and the charging module 44 are integrally used to be a power source supplying the apparatus 4. The power source is made such as solar energy, wireless charging technology, or the various types of batterys.

The outward appearance of the pen-type optical indexing apparatus may be referred to FIG. 5 schematically describing the pen-type optical indexing apparatus according to first embodiment.

A solar panel 51 is disposed onto the housing of the pen-type optical indexing apparatus 5, and used to transform the energy of lights into electrical signals. The solar panel 51 is exemplarily a module disposed on a top portion of the pen-type optical indexing apparatus 5. The lower portion of the apparatus 5 is provided for the user to handhold as well remaining the performance of the solar panel 51 to receive lights.

One or more types of control interfaces may be disposed onto the housing as requires. As shown in the figure, a first control interface 52 such as wheel-type interface may operate as the scrolling wheel of the conventional computer mouse under a specific operational mode. The wheel is used to scroll the pages in the graphic user interface, or to switch the displayed objects. A second control interface 53 exemplified by button(s) may operate as the left and right buttons or other keys of the computer mouse. It is noted that the first and second control interfaces 52, 53 may be utilized to be an auxiliary interfaces to perform the operations such as rotation, zooming, towing, and/or continuous movement. It is noted that the number of the interfaces (52, 53) of the pen-type optical indexing apparatus 5 according to the exemplary example in the present invention may not be limited. Further, the first or second control interface 52, 53 may be implemented, but not limited to, as mechanical wheel or button. In an exemplary example, a touch screen may also be one option to implement the control interface; that means a touch-sensitive sensor (not shown) is disposed onto the inner wall of the pen-type optical indexing apparatus 5. The inner touch-sensitive sensor allows the user to touch the outer surface of the pen-type optical indexing apparatus 5, and operate as controlling the computer cursor using the conventional computer mouse, handwriting, plotting, or clicking.

The light passage 54 at the pen tip of the pen-type optical indexing apparatus 5 allows the lights irradiating out of the apparatus 5, and successfully reaching the surface 50. The lights are then reflected by the surface 50 and re-enter the apparatus 5 through the light passage 54. The light passage 54 is preferably located at an opposite position to the inside light source.

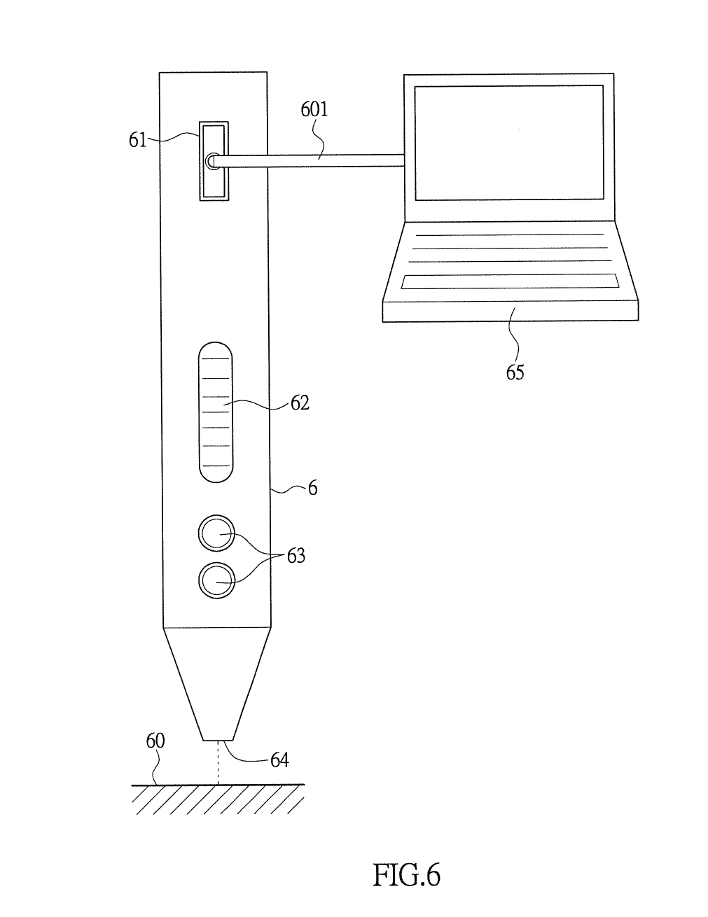

Reference is made to FIG. 6 schematically showing the pen-type optical indexing apparatus according to second embodiment.

According to the present example of the pen-type optical indexing apparatus 6, a connection interface 61 is disposed on the housing. A wired connection interface is exemplified to utilize a connecting line 601 to link a computer host 65. The connection interface 61 is used to deliver the control instructions. Further, via this connecting line 601, the apparatus 6 may takes power directly from the computer host 65.

The user interfaces such as the first control interface 62 and/or the second control interface 63 may be disposed on the housing of the optical indexing apparatus 6. The operations made by the first or second control interface 62, 63 can be activated according to an operational mode made to the apparatus 6. Similarly, a light passage 64 is disposed at an end of the pen-type optical indexing apparatus 6. The light passage 64 allows the lights emitted out of the apparatus 6, and reach a surface 60, and also re-enter the apparatus 6 through the light passage 64.

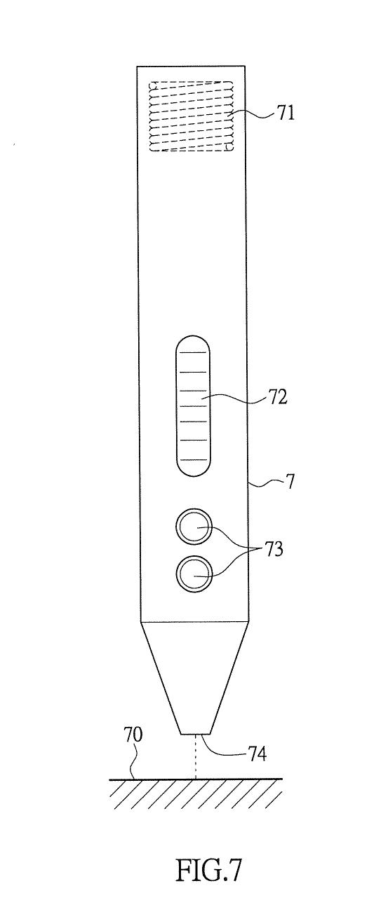

FIG. 7 shows one further pen-type optical indexing apparatus according to third embodiment of the present invention.

The pen-type optical indexing apparatus 7 is exemplified by disposing a wireless charging coil 71 at a portion of the apparatus 7. The wireless charging coil 71 may not appear at the outward appearance of the apparatus 7, but inside the apparatus 7. The wireless charging coil 71 is utilized to implement a mechanism of wireless charging. While the pen-type optical indexing apparatus 7 needs to be charged, the wireless charging coil 71 is connected with a charging device for the power charging so as to generate power with the induction coil. The electric energy may be stored in the charging module, e.g. chargeable battery, of the pen-type optical indexing apparatus 7.

Not only the first and second control interfaces 72, 73 embodies the tangible wheel and buttons of the computer mouse, but also the touch-sensitive sensor which is utilized to function screen touching. While the light passage 74 is disposed at an end of the pen-type optical indexing apparatus 7 and opposite to the position of the light source, the lights may reach the surface 70 and re-enter the apparatus 7 successfully.

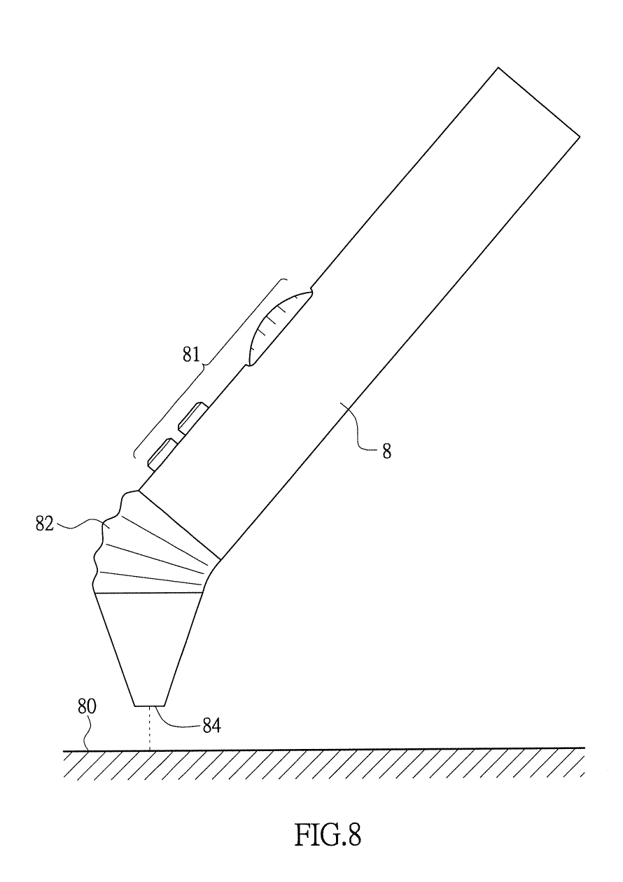

To allow the user to comfortably hold the pen-shaped apparatus, the pen-type optical indexing apparatus schematically shown in FIG. 8 is provided. Generally, the user operates the apparatus with an inclined angle when he holds the pen-type optical indexing apparatus 8. According to the present embodiment, the various types of control interface 81 are disposed on the housing. A light passage 84 is disposed at the pen tip, and directed to a surface 80. It is preferred that the portion of pen tip is directed to the surface 80 with a nearly vertical angle for allowing the lights to pass through the light passage 84.

In order to meet the need to handhold the apparatus, an angle-adjustment member 82 is provided for adjusting the tilt angle of the portion of pen tip against a contact surface. The angle-adjustment member 82 allows the portion of pen tip which contacts the surface 80 to be perpendicular to the surface 80 even though the user holds the apparatus 8 as the usual way. Therefore the angle-adjustment member 82 allows the user conventionally to handhold the pen-type optical indexing apparatus with a tilt angle. It is noted that the light-source module and sensing module are still disposed inside the portion of pen tip while the angle-adjustment member 82 is at between the portion of pen tip and the body of the apparatus 8.

The pen-type optical indexing apparatus is able to connect with a computer host. The computer host activates the functions made by the apparatus when it is installed with the driver for the pen-type optical indexing apparatus. By the driver, the pen-type optical indexing apparatus is driven to configure, for example, dots-per-inch (DPI), operational modes, and the operating functions.

When the driver receives control instructions from the pen-type optical indexing apparatus, the related operating system of the computer host reacts the instructions. For example, the driver is used to switch an operational mode for the pen-type optical indexing apparatus according to the instruction. When the indexing apparatus operates under a cursor-indicating mode, the instructions received by the driver will be converted to the movement of cursor. When the indexing apparatus operates under a handwriting mode, the driver converts the received instructions into continuous movement signals for drawing a track. Therefore, the track forms a handwriting trace on a display. The movement signals may also be used to conduct plotting, or character recognition of handwriting. Under a touching mode, the optical indexing apparatus operates over a touch display and generates indication signals for the touch display. It is noted that, while the apparatus is under the touching mode, the touch display may be configured to deactivate its touching function, so as to prevent signal interference as simultaneously generating the touch signals and the signals made by the indexing apparatus. The coordinates over the touch display will be computed by the driver for the apparatus.

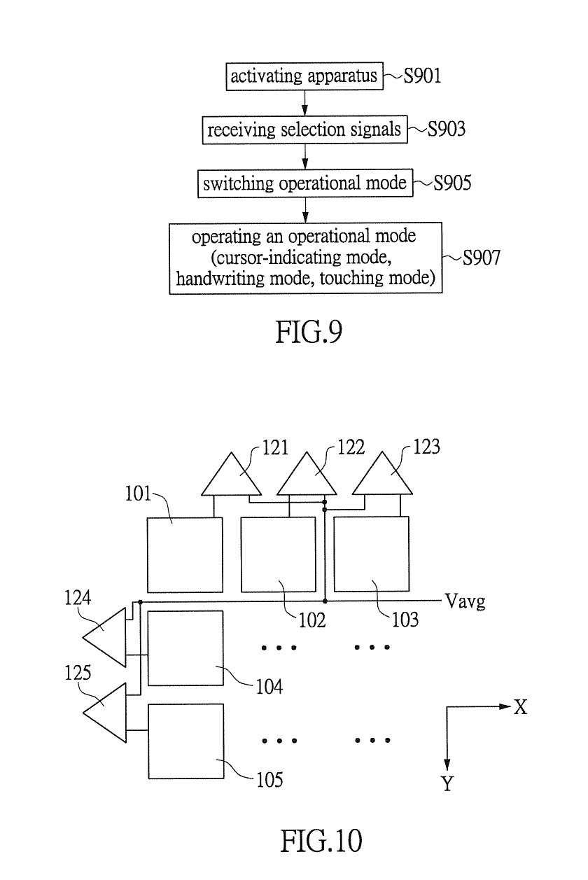

The several operational modes functioned to the pen-type optical indexing apparatus are exemplarily described in the above embodiments, and a control method for conducting the operational mode is exemplarily depicted in the flowchart of FIG. 9.

The indexing apparatus may enter a default operational mode as switching the operational modes for operating the pen-type optical indexing apparatus. Such as step S901, the default operational mode may be configured to be a specific operational mode for common use, or made by user's configuration. For example, the user may use the driver installed in the computer host to configure the operational mode. The pen-type optical indexing apparatus may store the record using the previous operational mode before shutdown, for example, the record is stored in a memory unit of the indexing apparatus.

The apparatus enters an operational mode as turning on the apparatus. The apparatus may receive a selection signal or switching signal when the user manipulates the control interface to conduct switching (step S903); or the user uses the driver to make a selection of operational mode. The operational mode is entered according to the selection signal, such as step S905. The optical indexing apparatus therefore operates under the selected operational mode, such as step S907. The operational mode may be one of the aforementioned cursor-indicating mode, handwriting mode, and touching mode.

In one embodiment of the present invention, the optical indexing apparatus is allowed to operate over a surface as entering the cursor-indicating mode. The signals made by this operational mode are used for generating signals to control computer cursor. Further, the apparatus is allowed to operate over the surface as entering the handwriting mode, the driver will record the continuous movement signals. The movement signals form a continuous track for handwriting, and plotting. Still further, the apparatus can be functioned to operate over a touch display, such as LCD, OLED, or LED display under a touching mode. The any position made by the touching operation is positioned by the computer-end driver so as to generate indication signals for the touch display. The computer host or any host having the touch display is such as a smart phone, tablet, or a laptop having a touch display. It is still noted that the touch display may deactivate its touch function while the pen-type optical indexing apparatus enters the touching mode. This mechanism of deactivation of the touch function can avoid the interference of the touching signals and the signals made by this indexing apparatus.

Reference is now made to FIG. 10 describing calculating a distribution of the energies received by the sensing cells in the sensor array of the optical indexing module of the indexing apparatus.

Further, FIG. 10 schematically shows a layout of the sensor array. A plurality of sensing cells are arranged over an X-Y plane to form an “N×M” sensor array. It is noted that the geometric shape of the sensor array may be, but not limited to, symmetric rectangle, square, circle, or oval-shaped. The sensing cells 101, 102, 103, 104, and 105 are arranged in an array respectively along X and Y directions. It is noted that the practical number of the pixels is not limited to the figure. The circuit board with these sensing cells 101, 102, 103, 104, and 105 further includes other elements such as the comparators 121, 122, 123, 124, and 125. The every comparator correspondingly associates with a sensing cell. The input value is the average voltage signal Vavg generated by the every sensing cell. This average voltage signal Vavg is compared with voltage signal generated by the sensing cell as receiving the light. The comparison results in the high or low voltage value. At last, it is featured to determine the moving direction by acquiring the comparisons of the two adjacent sensors in the tracing method.

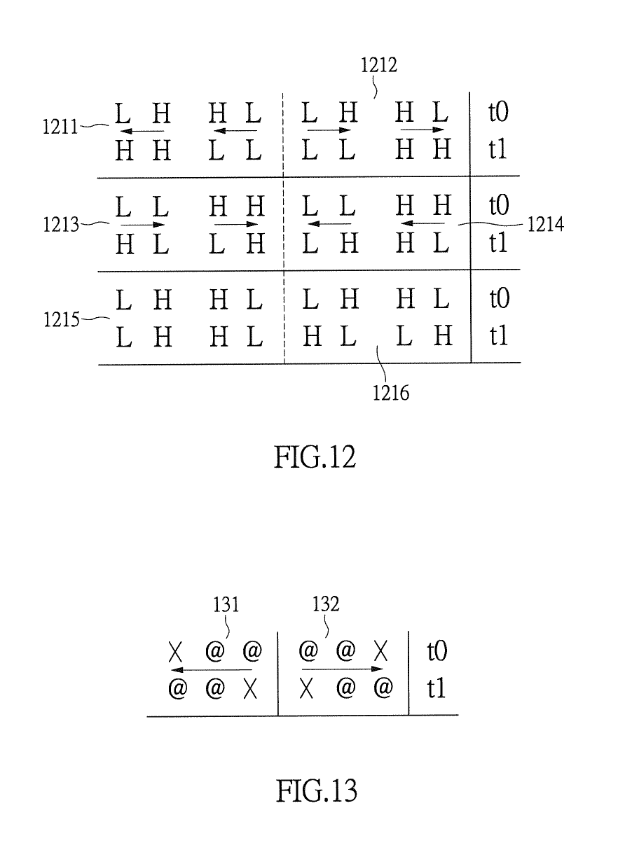

In the diagram, the shown comparator 121 is coupled to the sensing cell 101. An input signal is such as the energy signal generated by the sensing cell 101. The signal may be indicated by a voltage signal. The other input end shows an average voltage signal Vavg. The comparator 121 is used to compare the two inputs, and output a comparison result. In one embodiment, a binary characteristic value (H/L) is used to indicate this comparison result. The high and low voltage signals are respectively expressed by the characters H and L that as shown in FIG. 12.

According to one of the embodiments, the light tracing method applied to the optical indexing module in the pen-type optical indexing apparatus is featured that an energy distribution over a plane is formed by depicting the constructive and destructive interference patterns of the reflected coherent lights. The change of the energy distribution at different times may be used to determine a moving vector. In an exemplary embodiment, a scheme of non-relative viewpoints is introduced to performing movement judgment. The scheme incorporates the energy information of the surrounding sensing cells of the sensor chip to be compared with the average energy, so as to determine a moving direction. It is noted that, rather than the general method for determining the moving vector by the information extracted from the sensing cells.

To the cursor control, in one layout of the sensor chip of an exemplary embodiment, the sensor chip includes the sensor pixels arranged in an array. The sensing cells may include some inactive sensing cells, said dummy sensing cells, disposed around the chip. The centered sensing cells are the active area to receive the lights. Therefore, while the control circuit or the related calculation circuit receives the energy signals from the sensor chip, only the energies made by the non-dummy sensing cells are adopted to perform the calculation and further application. It is noted that those dummy sensing cells would not provide the energy signals for determining the movement vector, but for verifying the light signals. Reference is made to the layout of the sensing cells shown in FIG. 11.

The array-formed sensing cells include some dummy sensors at surrounding area and the centered pixels. One major purpose of the disposal of the dummy sensors is to even the whole sensor chip in the manufacturing process. The energies are also received evenly by the sensor chip. In the diagram of the embodiment, the surrounding the chip are configured to be the inactive dummy sensing cells 1111, 1112, 1113, 1114, 1115, and 1116. The sensing cells 1121, 1122, 1123, and 1124 near the central area are the major portion to receive the signals.

When the sensing cells are simultaneously exposed under the reflected lights, the centered pixels may evenly sense the photo signals. The surrounding sensing cells may possibly receive uneven energies. The unstable or uncertain energies made by the dummy sensing cells (1111, 1112, 1113, 1114, 1115, 1116) may be excluded while the total energy of the sensor chip is calculated. Therefore, this scheme allows the apparatus to acquire reference energy with better referral value.

As the diagram shows, a summation component 111, electrically connected with the every sensing cell of the sensor chip, is provided in the circuit. The summation component 111 is able to receive the photocurrent from the every sensing cell, and perform analog-to-digital conversion thereon. In which, a gain amplification process may be introduced to efficiently receiving the reference value since the photocurrent received by the every sensing cell is tiny. The energy change within the period of time may be obtained from the amplified energies. After that, an output signal is formed when the photocurrents made by the sensor pixels are processed by the gain amplifier 112. The output is likely represented by an output voltage Vout. Through a calculator 113, an average energy can be obtained from the available received energies and outputted. The output is such as the average voltage signal Vavg.

The above-mentioned output signals such as the output voltage Vout and the average voltage signal Vavg are outputted to the comparator, e.g. comparator of FIG. 10. The comparator compares the energy signal made by the every sensing cell and a reference value such as the average energy from all or part of the sensing cells. Therefore, an energy state for the every sensing cell is defined. For example, the energy state of every sensing cell may be represented by a binary characteristic value “H” abbreviated from high or “L” abbreviated from low.

In the operation of determining the cursor movement, the control unit is used to dynamically adjust the energy generated by the light-emitting unit based on the information related to the energy. For example, the driving current of the light-emitting unit may be controlled for adjusting the output energy. Further, the exposure time for receiving the incident lights for every sensing cell of the light-sensing unit may also be controlled. A gain of the output energy is also an adjustable factor. The photo energy received by the every sensing cell within a time slot may be acquired. Accordingly, the scheme using the mentioned sensor array allows the optical indexing apparatus to adapt to the various conditions of surfaces as introducing a compensation mechanism made by the adjustable intensity and brightness of the light source with the adjustable exposure time. The various conditions of the surfaces exemplarily indicate the various surface structures and a distance between the surface and the optical indexing apparatus.

It is worth noting that the movement signal made by the optical indexing apparatus is incorporated to controlling the cursor of its connected computer host. Further, the movement signal, if taken from the optical indexing apparatus with a touch display, may be used with a control signal made by using a simulated control interface displayed on the touch display as the general optical indexer does.

The method to determine the moving direction by computing the change of energies within a specific time interval of every sensing cell may be referred to the schematic diagram in FIGS. 12 and 13. One of the ways to compute the change of energy made by the sensing cell is to dispose a comparator to compare the received energies and the statistic energy value. The spatial interference within the time slot is accordingly formed.

The determination of the moving vector made by the binary characteristic value (H/L) may be referred to the light tracing method exemplarily described in FIG. 12.

The exemplary diagram shows a plurality of sensing cell groups 1211, 1212, 1213, 1214, 1215, and 1216 arranged in an array. It schematically shows the energy change between the adjacent sensing cells at different times, e.g. first time t0 and second time t1. The energy change is used to determine the moving vector.

In FIG. 12, the time labels “t0” and “t1” represent the two sampling times. The labels “H” and “L” respectively represent the high and low voltage signals outputted by the comparator. The labels “H” and “L” indicate the two types of energy states since two energies at two moments are compared with an average. This energy state indicated of an energy change may be expressed by the binary characteristic value (H/L). The voltage signals at the different times show a transition of the movement so as to determine the overall moving vector.

For example, a sensing cell group 1211 includes several sensing cells at different energy states. It is shown at the left side of the diagram that the two sensing cells are in different states at the first time t0, and exemplarily the sensing cells respectively senses two states “L” and “H” (from left to right). The energy states “L,H” at the first time t0 are then transformed to the energy states “H,H” at the second time t1. It means the energy states of the two sensing cells are transformed to the states “H,H” at the next moment. In which, it is determined that the energy state “L(t0)” of one of the sensing cells is transformed to state “H(t1)”, and it appears that the energy state “H” at the right position shifts to left position at the next moment. Therefore, in accordance with the present invention, it determines that the effective moving direction is from right to left within this sampling time.

Further, the energy states of another pair of sensing cells in this sensing cell group 1211 are “H,L” at the first time t0; Next, at the second time t1, the energy states are transformed to next states “L,L”. In which, the energy state of one of the sensing cells is from state “H” to state “L”. It appears that the energy state “L” at the right position shifts to left position. It therefore shows the effective moving direction is from right to left.

Next, within the sensing cell group 1212, the energy states “L,H” of the left two sensing cells at the first time t0 are transformed to states “L,L” at the second time t1. It shows the energy state “H” at the right position is replaced by the state “L” originally at left position. It therefore determined that the moving vector indicative of a direction from left to right.

Similarly, the energy states of the right two sensing cells in the sensing cell group 1212 are “H,L” at the first time t0. At the second time t1, the energy states are transformed to next states “H,H”. It shows the state “L” at the right position is replaced with the state “H” at the left position. It also determines that the moving vector indicative of the direction from left to right.

Further, there is no any arrow shown for the sensing cell groups 1215 and 1216 after the determination shows there is no energy change therein. In which, the energy states for the sensing cells are not changed from the first time t0 to the second time t1; or the change may not be qualified to determine any movement. For example, it is not able to determine the moving direction by this change since the energy states of the pixels in the sensing cell group 1216 are “L,H” at the first time t0, and be transformed to “H,L” at the second time t1. Therefore, the sensing cell group 1216 does not output any effective signal.

It consequently determines an overall moving vector by integrating all the obtained moving vectors when all the energy changes of all the sensing cells are completely determined within the period of sampling time.

One further embodiment for determining the movement may be referred to FIG. 13. FIG. 13 shows a schematic diagram depicting the method of light tracing.

The shown aspect for recognizing the moving vector is based on the transformation of the energy states of the sensing cells at different times. The label “X” indicates meaningless value; and label “@” shows the available sensing signal be found between the times t0 and t1. The aspect utilizes the change among the labels to determine the moving vector.

The signal energies received by the multiple sensing cells in the sensor chip can be compared with an average at the different times while the sensor chip receives the reflected light. The comparison results in high or low voltage signal. For example, the label “@” shown in the diagram represents the available voltage signal. In some conditions, it is labeled as “X” when no energy change or no meaningful voltage signal fluctuation can be found.

In the embodiment shown in FIG. 13, in the sensing cell group 131, the label “X@@” shows the comparator found the energy change among the adjacent sensing cells at the first time t0. At the second time t1, the energy change made to the sensing cells are labeled as “@@X”. When the energy state “X@@” at the first time t0 are transformed to the state “@@X” at the second time t1, it appears that the label “@@” are shifted to left position. It is therefore a leftward shift in the sensing cell group 131 determined, as the arrow shows in the diagram.

Further, in the sensing cell group 132, the energy state of the adjacent sensing cell is “@@X” showing the energy change occurred at the first time t0; and the energy state is “x@@” at the second time t1. The transformation is made between the times t0 and t1, and it shows the label “@@” is rightward shifted. The method of light tracing may therefore adopt this scheme to determine the overall movement within a period of time.

It is worth noting that any tiny error made to the sensor array incorporated in the apparatus of the present invention may not influence correct determination of the movement. When the light tracing method is applied to an optical computer mouse, the slow change of the reference signals may not influence the overall determination because the shifting rate as manipulating the mouse is far lower than the processing rate of the control circuit within the apparatus.

In summation, the structural design of the pen-type optical indexing apparatus in accordance with the present invention is for the user easily to hold. The pen tip has an opening. The light source is preferably a Laser. While the pen-type optical indexing apparatus irradiates lights, the lights are reflected by a surface and received by the arrayed sensing cells. The apparatus may draw a moving track based on the sensed signals. Therefore, the apparatus may operate as a computer cursor, plotting, or touching function.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A pen-type optical indexing apparatus, comprising:
a housing of the pen-type optical indexing apparatus, having a light passage, wherein the housing comprises:
a control unit, used to integrate circuit signals inside the pen-type optical indexing apparatus, and generate movement signals;
a control interface unit, electrically connected with the control unit, provided for generating control signals to operate the pen-type optical indexing apparatus;
a light-source module, electrically connected with the control unit, providing a light source to emit lights out of the pen-type optical indexing apparatus through the light passage of the indexing apparatus;
a sensing module, electrically connected with the control unit, comprising a plurality of arrayed sensing cells composing a sensor array, used to receive lights entering the pen-type optical indexing apparatus through the light passage;
a communication unit, electrically connected with the control unit, wherein the optical indexing apparatus is communicated with a computer host through the communication unit; and
a power management unit, electrically connected with the control unit, used to manage power supply to the optical indexing apparatus;
wherein, after the sensing cells of the sensing module receive energies within a sampling time, energy differences of spatial interference around the sampling time is obtained so as to determine a moving direction of the pen-type optical indexing apparatus and generate movement signals.

2. The apparatus of claim 1, wherein the light passage is a light entrance disposed at a pen tip of the pen-type optical indexing apparatus.

3. The apparatus of claim 2, wherein the housing of the pen-type optical indexing apparatus is disposed with an angle-adjustment member which is used to adjust a tilt angle of the pen tip against a contact surface.

4. The apparatus of claim 2, wherein the arrayed sensing cells of the sensor array includes a plurality of dummy sensing cells; the sensor array is used to receive incident lights reflected from a surface via the light passage.

5. The apparatus of claim 4, wherein, a fixed distance is existed between the sensing cells which are arranged with uniform relative positions.

6. The apparatus of claim 5, wherein the dummy sensing cells are disposed in peripheral area of the sensor array.

7. The apparatus of claim 6, wherein the light source is a laser with great spatial coherence.

8. The apparatus of claim 7, wherein the control unit, the light-source module, and the sensing module are integrated into an integrated circuit.

9. The apparatus of claim 1, wherein the communication unit providers wired or wireless communication method to connect with the computer host.

10. The apparatus of claim 9, wherein the wireless communication method is connected with the computer host via a connection interface.

11. The apparatus of claim 1, wherein the control interface unit includes a tangible switch disposed on the housing of the optical indexing apparatus.

12. The apparatus of claim 11, wherein the tangible switch includes a wheel and one or more buttons.

13. The apparatus of claim 1, wherein the power management unit is connected with a charging module.

14. The apparatus of claim 13, wherein the charging module is a solar energy charging module.

15. The apparatus of claim 13, wherein the charging module has a wireless charging coil.

16. A control method for the pen-type optical indexing apparatus according to claim 1, comprising:
entering one of multiple operational modes as activating the pen-type optical indexing apparatus;
wherein, if a selection signal is received, the one operational mode is entered in response to the selection signal.

17. The control method of claim 16, wherein, the one operational mode is selected by switching the tangible switch of the housing.

18. The control method of claim 17, wherein the multiple operational modes include a cursor-indicating mode, and the pen-type optical indexing apparatus operates over a surface and generates signals for controlling a computer cursor.

19. The control method of claim 17, wherein the multiple operational modes include a handwriting mode, and the pen-type optical indexing apparatus operates over a surface and generates signals to draw a continuous path.

20. The control method of claim 17, wherein the multiple operational modes include a touching mode; the pen-type optical indexing apparatus operates over a touch display, and generates indication signals for the touch display; wherein the touch display disables touch function as entering the touching mode of the apparatus.
